(19) United States
(12) Patent Application Publication
(10) Pub. No.: US 2005/0102612 A1
(43) Pub. Date: May 12, 2005

(54) Web-enabled XML editor

(75) Inventors: Ronald Campbell Allan, Austin, TX (US); John Winston Bolinger, Austin, TX (US); C. Eric Dunn, Round Rock, TX (US); Anmol Matada, Austin, TX (US); Jill Elizabeth Palmer, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/703,755

(22) Filed: Nov. 6, 2003

(51) Int. Cl. G06F 15/00; G06F 3/00

(52) U.S. Cl. 715/513; 715/760; 715/749

(57) ABSTRACT

A Web-enabled document editor is provided that is supported by any browser application. The server receives a document type definition and creates a Web-based editor for the document type. The Web-based editor page, which may be an HTML page with JavaScript, is sent to the client for presentation on a browser. The user may add and delete elements from the document type definition using the editor interface. The user may supply content for the elements in the browser. The user may also view the XML source or the formatted document using the editor interface.

### BACKGROUND OF THE INVENTION

1. Technical Field

The present invention relates to data processing systems and, in particular, to document editors. Still more particularly, the present invention provides a method, apparatus, and program for providing a Web-enabled document editor.

2. Description of Related Art

HyperText Markup Language is a document format used on the World Wide Web. Web pages are text documents built with HTML tags embedded in the text. HTML defines the page layout, fonts, and graphic elements as well as hypertext links to other documents on the Web. HTML is derived from the Standard Generalized Markup Language (SGML).

A subset of SGML is known as extensible Markup Language (XML). XML is used for defining data elements on a Web page and business-to-business documents. XML uses a similar tag structure as HTML; however, whereas HTML defines how elements are displayed, XML defines what those elements contain. HTML uses predefined tags, but XML allows tags to be defined by the developer of the page. Thus, virtually any data items can be identified, allowing Web pages to function like database records.

XML tags are defined in an XML Schema, which defines content type as well as name. XML tags can also be described in a Document Type Definition (DTD) format, since XML is a subset of the SGML language. Unlike HTML, which uses a rather loose coding style and which is tolerant of coding errors, XML pages must be “well formed,” which means they must comply with rigid rules.

HTML and XML documents are primarily text documents. Therefore, HTML and XML documents can be created and edited using a simple text editor. However, the complexity of the documents and the structure to which they must conform makes this a difficult task. Therefore, an HTML- or XML-specific editor may be used. These editors may be implemented in a variety of ways. For example, a stand-alone application may be provided. Web-based editors also exist.

A Web-based solution is preferred because the author need not install heavy software on the client and, theoretically, the editor may be supported by any computer with a Web browser application. However, existing Web-based editors rely on proprietary browser technology. Some Web-based XML editors require a Java applet to be downloaded. Other Web-based XML editors use browser-specific application programming interfaces (APIs). Still others limit the number of elements that may be added to a document.

### SUMMARY OF THE INVENTION

The present invention recognizes the disadvantages of the prior art and provides a Web-enabled document editor that is supported by any browser application. The server receives a document type definition and creates a Web-based editor for the document type. The Web-based editor page, which may be an HTML page with JavaScript, is sent to the client for presentation on a browser. The user may add and delete elements from the document type definition using the editor interface. The user may supply content for the elements in the browser. The user may also view the XML source or the formatted document using the editor interface.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a block diagram illustrating an XML editor system in accordance with a preferred embodiment of the present invention;

FIG. 5 illustrates an example XML editor page structure in accordance with a preferred embodiment of the present invention;

FIG. 6 illustrates an example XML editor user interface in accordance with a preferred embodiment of the present invention;

FIG. 7 is a flowchart illustrating the operation of a server in accordance with a preferred embodiment of the present invention; and

FIG. 8 is a flowchart illustrating the operation of a client in accordance with a preferred embodiment of the present invention.

### DETAILED DESCRIPTION OF THE PREFERRED EMBODIMENT

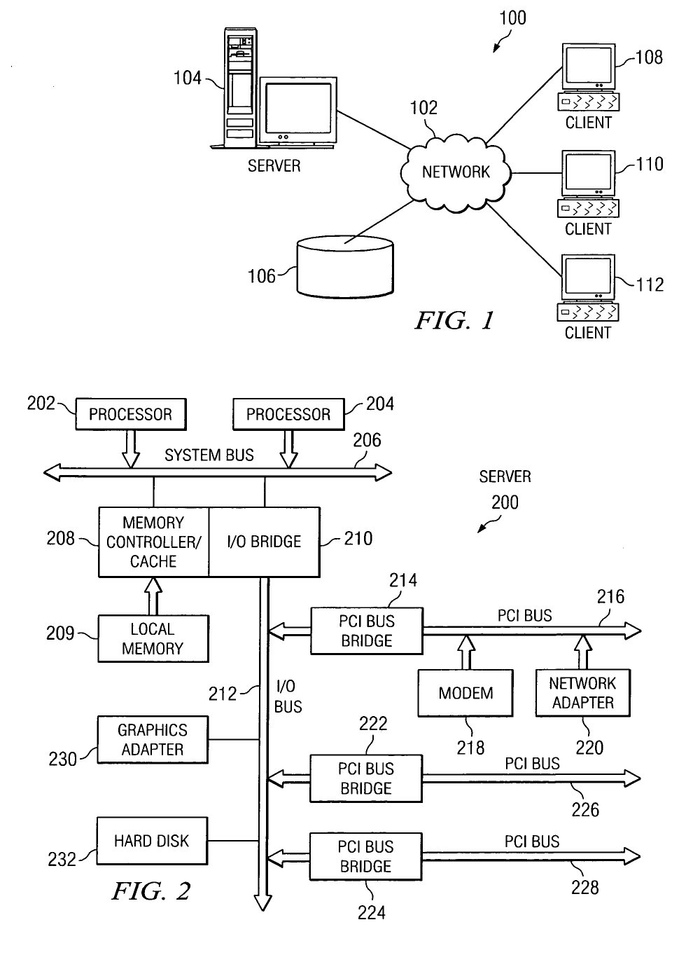

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In accordance with a preferred embodiment of the present invention, server 102 provides a Web-enabled extensible Markup Language (XML) editor to clients 108, 110, 112. A user of a client sends a document type definition (DTD) file to the server or selects an existing DTD file. A document type definition is a language that describes the contents of an SGML document. The DTD is also used with XML, and the DTD definitions may be embedded within an XML document or in a separate file.

Whereas HTML defines how elements are displayed, XML defines what those elements contain. HTML uses predefined tags, but XML allows tags to be defined by the developer of the page, through the DTD. Thus, virtually any data items, such as product, sales rep, amount due, and the like can be defined, allowing Web pages to function like database records. For example, if the user wishes to create a frequently asked questions (FAQ) document, the user may select an existing FAQ DTD. The server generates a Web-based XML editor page. In an exemplary embodiment, the XML editor page is a HyperText Markup Language (HTML) page and JavaScript that are generated dynamically based upon the DTD.

The XML editor user interface (UI) design may consist of frames. One of the frames, referred to as a navigation frame, may present a tree representation of the DTD. The XML editor page may include a navigation frame, which includes the information from the DTD. The editor frame may include tabs including a tab for the XML editor, a tab for viewing the XML source, and a tab for viewing the formatted document.

The editor page is sent to the client and presented to a user at the client. The user may select elements from the navigation frame to add to or delete from the document. The elements are then presented in an editor frame. The user may create or edit the content of the elements in a form-based interface in the editor frame. The user may then check his or her work by viewing the XML source or the formatted document.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pseries system, a product of International Business Machines Corporation in Armonk, N.Y., running the Advanced Interactive Executive (AIX) operating system or LINUX operating system.

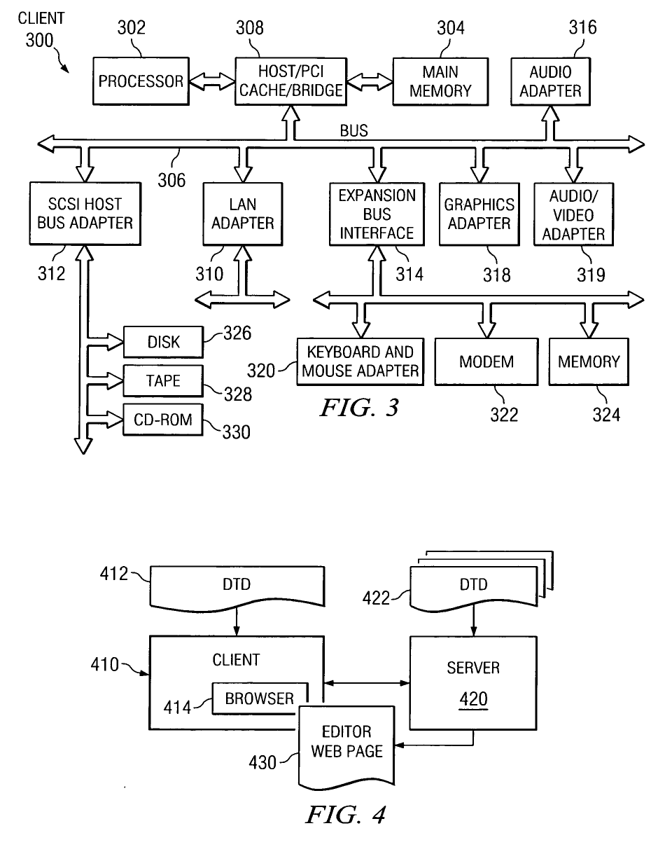

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

FIG. 4 is a block diagram illustrating an XML editor system in accordance with a preferred embodiment of the present invention. Client 410 communicates with server 420. Client 410 requests an XML editor and provides DTD 412 to server 420. Alternatively, client 410 may select an existing DTD from DTDs 422 at server 420. All the required HTML and JavaScript is generated on the server side. The server generates a Web-based XML editor page 430 and returns this page to client 410. Alternatively, if the client disables JavaScript, the server may replace the JavaScript file with links and methods to the server for server-side processing. The user would notice no change in the UI design.

The server may detect whether JavaScript is enabled in the client browser by having an HTML form in a home page with a hidden field having a preset value. The browser will change the value using the JavaScript and submit it as soon as the page gets loaded on the browser. If the browser is not JavaScript enabled, then the value the server gets when the page is submitted will be the original preset value; otherwise, the server gets a changed value. The server may use other techniques for determining whether JavaScript is enabled at the client, such as cookies.

Editor Web page 430 may be an HTML page with JavaScript. The editor is generated based upon the selected DTD and includes a navigation frame. An editor frame may include tabs for the editor, an XML viewer, and a formatted document viewer. The editor Web page may be presented using browser application 414. The user may select elements to add or delete from the navigation frame. The editor itself is form-based. The user may edit the content of the elements using this user interface.

New functions may be added to the XML editor without modifying the base code. The editor may include a property file, which is a simple file that contains a name of the function, display name, and a uniform resource locator (URL) or JavaScript method. Since all the functions on the editor are “href” links or buttons, a new function may be added by simply sending a new page that includes the JavaScript/HTML to be added to the project and reference information in the properties file.

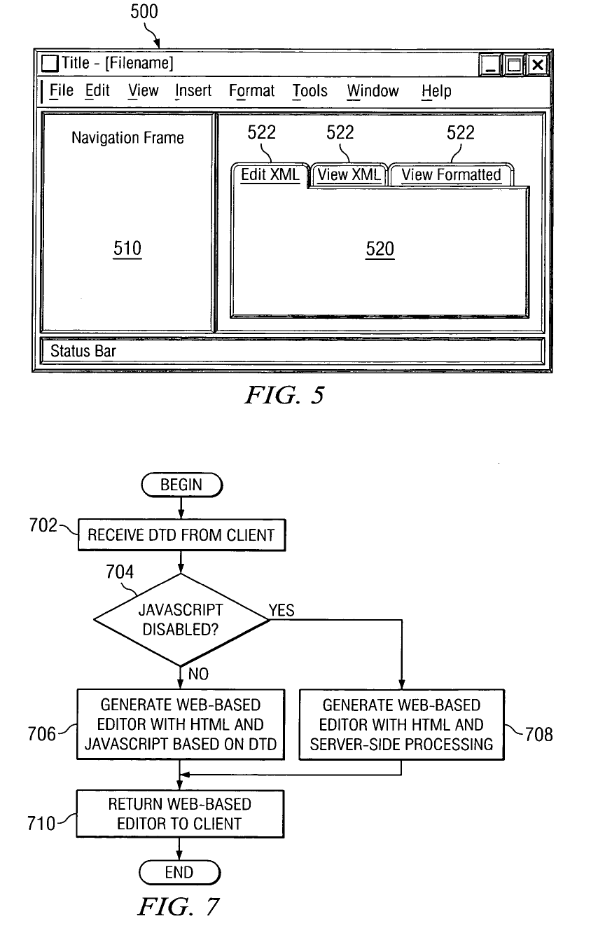

FIG. 5 illustrates an example XML editor page structure in accordance with a preferred embodiment of the present invention. Window 500 presents the XML editor page, which includes navigation frame 510 and editor frame 520. The XML editor user interface is based upon a selected DTD. A tree representation of the DTD is presented in navigation frame 510. The user may select elements from the DTD for addition to or deletion from the XML document in the navigation frame. The user may add any number of unbounded elements, because the HTML elements are dynamically generated using JavaScript on the client side, rather than being pre-generated on the server side.

In the depicted example, the editor frame has tabs 522. The “Edit XML” tab allows the user to edit the elements of the document. The elements are presented in a form-based user interface. The “View XML” tab allows the user to view the XML source for the document. The “View Formatted” tab allows the user to view the formatted document.

While the editor UI is shown as a tabbed frame, other techniques may be used. For example, the “View XML” and “View Formatted” components may be alternatively presented in separate frames. Also, more or fewer tabs may be used. For example, the UI may include a “Help” tab or other tabs depending upon the implementation.

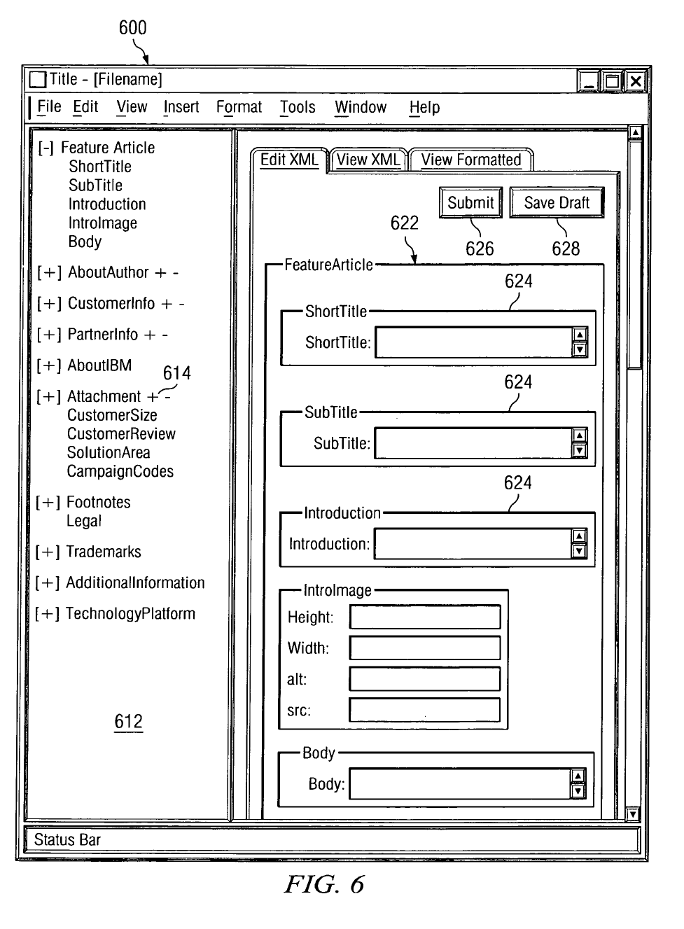

FIG. 6 illustrates an example XML editor user interface in accordance with a preferred embodiment of the present invention. Window 600 presents the XML editor page, which includes a navigation frame and an editor frame. The XML editor user interface is based upon a selected DTD. A tree representation 612 of the DTD is presented in the navigation frame.

Addition/deletion buttons 614 allow users to add new elements to the document or delete elements from the document. When an element is added, its input fields are shown in the editor frame. For example, element 622 is shown under the “Edit XML” tab and sub-elements are shown with input fields 624. The user may edit the document by adding elements from the navigation frame and entering the contents into input fields 624 in the editor frame. When finished, the user may submit the document to the server or another application by selecting “Submit” button 626. The user may also save a draft of the document by selecting “Save Draft” button 628.

Turning to FIG. 7, a flowchart is shown illustrating the operation of a server in accordance with a preferred embodiment of the present invention. The process begins and receives a DTD from the client (step 702). A determination is made as to whether JavaScript is disabled at the client (step 704). If JavaScript is not disabled, the process generates a Web-based editor with HTML and JavaScript for client-side processing based on the DTD (step 706). Otherwise, if JavaScript is disabled at the client, the process generates a Web-based editor with server-side processing based on the DTD (step 708).

The server may also detect cyclic references by detecting the graph in the DTD. The server may then correct the DTD by replacing the element at the beginning of the loop with a #PCDATA element. This removes the cycle from the DTD and gives the user the ability to insert the required content or continue with the cycle. After the editor is generated in step 706 or step 708, the process returns the Web-based editor page to the client (step 710) and ends.

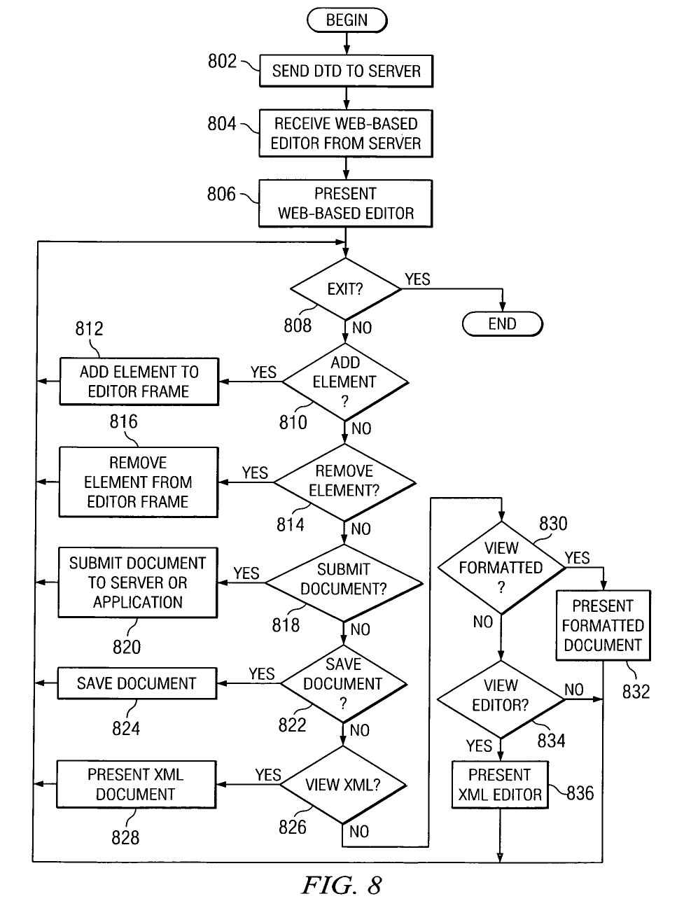

FIG. 8 is a flowchart illustrating the operation of a client in accordance with a preferred embodiment of the present invention. The process begins and sends a DTD (or a user selection of a DTD) to the server (step 802). Then, the process receives a Web-based editor page from the server (step 804) and presents the Web-based editor using a Web browser (step 806). Next, a determination is made as to whether an exit condition exists (step 808). An exit condition may exist, for example, when the user closes the browser window or opens another Web document in the browser. If an exit condition exists, the process ends.

If an exit condition does not exist in step 808, a determination is made as to whether the user selects to add an element to the XML document (step 810). If the user selects to add an element, the process adds the element to the editor frame (step 812) and the process returns to step 808 to determine whether an exit condition exists.

If the user does not select to add an element in step 810, a determination is made as to whether the user selects to remove an element from the XML document (step 814). If the user selects to remove an element, the process removes the element from the editor frame (step 816) and the process returns to step 808 to determine whether an exit condition exists.

If the user does not select to remove an element in step 814, a determination is made as to whether the user selects to submit the XML document to a server or application (step 818). If the user selects to submit the document, the process submits the document (step 820) and the process returns to step 808 to determine whether an exit condition exists.

If the user does not select to submit the document in step 818, a determination is made as to whether the user selects to save the XML document (step 822). If the user selects to save the document, the process saves the document (step 824) and the process returns to step 808 to determine whether an exit condition exists.

If the user does not select to save the document in step 822, a determination is made as to whether the user selects to view the XML source for the document (step 826). If the user selects to view XML, the process presents the XML source for the document (step 828) and the process returns to step 808 to determine whether an exit condition exists.

If the user does not select to view the XML source in step 826, a determination is made as to whether the user selects to view the formatted document (step 830). If the user selects to view the formatted document, the process presents the formatted document (step 832) and the process returns to step 808 to determine whether an exit condition exists.

If the user does not select to view the formatted document in step 830, a determination is made as to whether the user selects to view the XML editor (step 834). If the user selects to view the XML editor, the process presents the form-based XML editor user interface (step 836) and the process returns to step 808 to determine whether an exit condition exists. If the user does not select to view the XML editor in step 834, the process returns to step 808 to determine whether an exit condition exists.

Thus, the present invention solves the disadvantages of the prior art by providing an HTML and JavaScript based XML editor interface, which is generated at the server and allows the client to build the required HTML presentation on the fly. The present invention supports the addition and editing of unbounded XML elements on the client side. The XML editor of the present invention is also able to switch from client-side processing to server-side processing without any change in the user interface and seamlessly to the user. The present invention also has the ability to add new functions without changing the base code.

The Web-based XML editor of the present invention does not require downloads, such as Java applets or other components. The present invention also does not require browser-specific APIs or other proprietary components. Therefore, the Web-based editor of the present invention can run on any browser that supports HTML and JavaScript.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for providing a Web-based editor, the method comprising:
obtaining a document type definition;
generating an editor user interface based on the document type definition; and
sending the editor user interface to a client,
wherein the editor user interface is a Web page that allows a user to edit a document of a type corresponding to the document type definition.

2. The method of claim 1, wherein the editor user interface includes HyperText Markup Language and JavaScript.

3. The method of claim 1, wherein the editor user interface does not require any further downloads.

4. The method of claim 1, wherein the editor user interface does not require any browser specific application program interfaces.

5. The method of claim 1, wherein the editor user interface does not limit the number of elements that can be added.

6. The method of claim 1, wherein the editor user interface provides an extensible markup language editor.

7. The method of claim 1, wherein the editor user interface includes links and methods to a server for server-side processing.

8. The method of claim 1, further comprising:
adding at least one function to the editor user interface without modifying base code.

9. The method of claim 1, further comprising:
detecting at least one cyclic reference in the data type definition; and
correcting the data type definition by removing the at least one cyclic reference.

10. The method of claim 9, wherein removing the at least one cyclic reference includes replacing an element at the beginning of the cyclic reference with a #PCDATA element.

11. An apparatus for providing a Web-based editor, the apparatus comprising:
means for obtaining a document type definition;
means for generating an editor user interface based on the document type definition; and
means for sending the editor user interface to a client,
wherein the editor user interface is a Web page that allows a user to edit a document of a type corresponding to the document type definition.

12. A computer program product, in a computer readable medium, for providing a Web-based editor, the computer program product comprising:
instructions for obtaining a document type definition;
instructions for generating an editor user interface based on the document type definition; and
instructions for sending the editor user interface to a client,
wherein the editor user interface is a Web page that allows a user to edit a document of a type corresponding to the document type definition.

13. The computer program product of claim 12, wherein the editor user interface includes HyperText Markup Language and JavaScript.

14. The computer program product of claim 12, wherein the editor user interface does not require any further downloads.

15. The computer program product of claim 12, wherein the editor user interface does not require any browser specific application program interfaces.

16. The computer program product of claim 12, wherein the editor user interface does not limit the number of elements that can be added.

17. The computer program product of claim 12, wherein the editor user interface provides an extensible markup language editor.

18. The computer program product of claim 12, wherein the editor user interface includes links and methods to a server for server-side processing.

19. The computer program product of claim 12, further comprising:
Instructions for adding at least one function to the editor user interface without modifying base code.

20. The computer program product of claim 12, further comprising:
instructions for detecting at least one cyclic reference in the data type definition; and
instructions for correcting the data type definition by removing the at least one cyclic reference.
